(19) United States
(12) Patent Application Publication
(10) Pub. No.: US 2026/0276872 A1
(43) Pub. Date: Sep. 17, 2026

(54) LAMINATE, COMPOSITE LENS, DISPLAY DEVICE, AND VIRTUAL REALITY DISPLAY DEVICE

(71) Applicant: FUJIFILM Corporation, Tokyo (JP)

(72) Inventor: Toshikazu SUMI, Minamiashigara-shi (JP)

(73) Assignee: FUJIFILM Corporation, Tokyo (JP)

(21) Appl. No.: 19/670,041

(22) Filed: May 7, 2026

Related U.S. Application Data
(63) Continuation of application No. PCT/JP2024/045379, filed on Dec. 23, 2024.

(30) Foreign Application Priority Data
Dec. 27, 2023 (JP) 2023-221409

(51) Int. Cl. G02B 5/00; G02B 1/04; G02B 5/30; G02B 27/01

(52) U.S. Cl. CPC G02B 5/003; G02B 1/04; G02B 5/3016; G02B 5/3033; G02B 5/3083; G02B 27/0101

(57) ABSTRACT

The present invention provides a laminate, a composite lens, a display device, and a virtual reality display device, in which color unevenness is less likely to occur in a case of being applied to a display device (particularly, a virtual reality display device) and being visually recognized. A laminate according to the present invention is a laminate including: a light absorption anisotropic film; and a pressure-sensitive adhesive layer disposed adjacent to the light absorption anisotropic film, in which the light absorption anisotropic film contains an organic dichroic coloring agent, and a total of a surface free energy E1 of a surface of the light absorption anisotropic film on a pressure-sensitive adhesive layer side and a surface free energy E2 of a surface of the pressure-sensitive adhesive layer on a light absorption anisotropic film side is 54.0 mNm⁻¹ or more.

### CROSS-REFERENCE TO RELATED APPLICATIONS

This application is a Continuation of PCT International Application No. PCT/JP2024/045379 filed on Dec. 23, 2024, which claims priority under 35 U.S.C. § 119(a) to Japanese Patent Application No. 2023-221409 filed on Dec. 27, 2023. The above applications are hereby expressly incorporated by reference, in their entirety, into the present application.

### BACKGROUND OF THE INVENTION

### 1. Field of the Invention

The present invention relates to a laminate, a composite lens, a display device, and a virtual reality display device.

### 2. Description of the Related Art

A light absorption anisotropic film containing an organic dichroic coloring agent is used for various applications. For example, a circular polarization plate is obtained by combining a light absorption anisotropic film and a retardation layer, and is used for preventing reflection of external light. In addition, the light absorption anisotropic film is used as a part of a member of a virtual reality display device.

JP2022-153544A discloses a light absorption anisotropic film containing a dichroic azo coloring agent compound. In addition, JP2022-153544A discloses an aspect in which a barrier layer is disposed between a light absorption anisotropic film and a pressure-sensitive adhesive layer.

### SUMMARY OF THE INVENTION

On the other hand, from the viewpoint of thickness reduction, it is desirable not to use the above-described barrier layer.

The present inventors have found that, in a case where a laminate obtained by directly laminating a light absorption anisotropic film and a pressure-sensitive adhesive layer without using a barrier layer is applied to a display device, there is a problem in that color unevenness occurs and display performance deteriorates. In particular, the present inventors have found that the above-described problem is remarkably generated in a case where the above-described laminate is applied to a virtual reality display device.

In view of the above circumstances, an object of the present invention is to provide a laminate which is unlikely to cause color unevenness in a case of being applied to a display device (particularly, a virtual reality display device) and being visually recognized.

In addition, another object of the present invention is to provide a composite lens, a display device, and a virtual reality display device.

As a result of intensive studies repeatedly conducted by the present inventors on the above-described problem, it has been found that the above-described problem can be achieved by the following configurations.

(1) A laminate comprising:
a light absorption anisotropic film; and
a pressure-sensitive adhesive layer disposed adjacent to the light absorption anisotropic film,
in which the light absorption anisotropic film contains an organic dichroic coloring agent, and
a total of a surface free energy E1 of a surface of the light absorption anisotropic film on a pressure-sensitive adhesive layer side and a surface free energy E2 of a surface of the pressure-sensitive adhesive layer on a light absorption anisotropic film side is 54.0 mNm⁻¹ or more.

(2) The laminate according to (1), in which a thickness of the light absorption anisotropic film is 10.0 μm or less.

(3) The laminate according to (1) or (2), in which the light absorption anisotropic film contains four or more kinds of organic dichroic coloring agents.

(4) The laminate according to any one of (1) to (3), further comprising: an alignment film disposed adjacent to the light absorption anisotropic film on a side of the light absorption anisotropic film opposite to the pressure-sensitive adhesive layer side.

(5) The laminate according to any one of (1) to (4), in which a thickness of the pressure-sensitive adhesive layer is 13.0 μm or less.

(6) The laminate according to any one of (1) to (5), further comprising: an adjacent layer disposed adjacent to the pressure-sensitive adhesive layer on a side of the pressure-sensitive adhesive layer opposite to the light absorption anisotropic film side, in which an elastic modulus of the adjacent layer is 100 MPa or more.

(7) The laminate according to any one of (1) to (6),
in which the light absorption anisotropic film contains a surfactant, and a Log P value of the surfactant is 3.0 or less.

(8) The laminate according to any one of (1) to (7),
in which a surface of the light absorption anisotropic film on the pressure-sensitive adhesive layer side is subjected to a surface activation treatment.

(9) The laminate according to any one of (1) to (8), in which a Log P value of the pressure-sensitive adhesive layer is 0.5 or less.

(10) The laminate according to any one of (1) to (9), further comprising: a retardation layer on a side of the pressure-sensitive adhesive layer opposite to the light absorption anisotropic film side.

(11) The laminate according to any one of (1) to (10), further comprising: a reflective polarizer and a retardation layer on a side of the pressure-sensitive adhesive layer opposite to the light absorption anisotropic film side.

(12) A composite lens comprising, in the following order:
the laminate according to any one of (1) to (11);
a lens; and
a half mirror.

(13) A display device comprising:
the laminate according to any one of (1) to (11).

(14) A virtual reality display device comprising: the laminate according to any one of (1) to (11).

According to the present invention, it is possible to provide a laminate in which color unevenness is less likely to occur in a case of being applied to a display device (particularly, a virtual reality display device) and being visually recognized.

In addition, according to the present invention, it is possible to provide a composite lens, a display device, and a virtual reality display device.

### BRIEF DESCRIPTION OF THE DRAWINGS

FIG. 1 is a diagram showing an example of a laminate according to the embodiment of the present invention.

FIG. 2 is a view showing another example of the laminate according to the embodiment of the present invention.

FIG. 3 is a view showing still another example of the laminate according to the embodiment of the present invention.

FIG. 4 is a view showing an example of a composite lens according to the embodiment of the present invention.

FIG. 5 is a view showing an example of a virtual reality display device according to the embodiment of the present invention.

### DESCRIPTION OF THE PREFERRED EMBODIMENTS

Hereinafter, the present invention will be specifically described.

The description of configuration requirements below may be made based on typical embodiments or specific examples, but the present invention is not limited to such embodiments.

Any numerical range expressed using “to” in the present specification refers to a range including the numerical values before and after the “to” as a lower limit value and an upper limit value, respectively.

In the present specification, “absorption axis” denotes a polarization direction in which an absorbance is the maximum in a plane in a case where linearly polarized light is incident. In addition, the “in-plane slow axis” means a direction in which a refractive index is maximized in a plane.

In addition, in the present specification, Re(λ) and Rth(λ) respectively represent an in-plane direction retardation at a wavelength λ and a thickness-direction retardation at a wavelength λ. Unless otherwise specified, it is assumed that the wavelength λ is 550 nm. In the present invention, Re(λ) and Rth(λ) are values measured at the wavelength of λ in AxoScan (manufactured by Axometrics, Inc.). By inputting the average refractive index ((nx+ny+nz)/3) and the film thickness (d) into the AxoScan,
in-plane slow axis direction (°)

$$Re ( λ ) = R 0 ( λ ) , and$$

$$Rth ( λ ) = ( ( nx + ny ) / 2 - nz ) \times d$$

are calculated.

Although R0 (λ) is displayed as a numerical value calculated by AxoScan, it means Re(λ).

In addition, in the present specification, the refractive indices nx, ny, and nz are measured using an Abbe refractometer (NAR-4T, manufactured by Atago Co., Ltd.), and a sodium lamp (λ=589 nm) is used as a light source. In addition, the wavelength dependence can be measured using a combination of a multi-wavelength Abbe refractometer DR-M2 (manufactured by Atago Co., Ltd.) and a dichroic filter.

In addition, the values in Polymer Handbook (John Wiley & Sons, Inc.) and catalogs of various optical films can be used. The values of average refractive index of major optical films are as follows: cellulose acylate (1.48), cycloolefin polymer (1.52), polycarbonate (1.59), polymethyl methacrylate (1.49), and polystyrene (1.59).

In the present specification, the A-plate and the C-plate are defined as follows.

There are two types of A-plates, a positive A-plate (A-plate which is positive) and a negative A-plate (A-plate which is negative). The positive A-plate satisfies a relationship of Expression (A1) and the negative A-plate satisfies a relationship of Expression (A2) in a case where a refractive index in a film in-plane slow axis direction (in a direction in which an in-plane refractive index is maximum) is denoted by nx, a refractive index in an in-plane direction orthogonal to the in-plane slow axis is denoted by ny, and a refractive index in a thickness direction is denoted by nz. The positive A-plate has an Rth showing a positive value and the negative A-plate has an Rth showing a negative value.

$$nx > ny \approx nz \qquad Expression ( A1 )$$

$$ny < nx \approx nz \qquad Expression ( A2 )$$

The symbol “≈” encompasses not only a case where both sides are completely the same as each other but also a case where both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

There are two types of C-plates, that is, a positive C-plate (C-plate which is positive) and a negative C-plate (C-plate which is negative). The positive C-plate satisfies a relationship of Expression (C1) and the negative C-plate satisfies a relationship of Expression (C2). The positive C-plate has an Rth showing a negative value and the negative C-plate has an Rth showing a positive value.

$$nz > nx \approx ny \qquad Expression ( C1 )$$

$$nz < nx \approx ny \qquad Expression ( C2 )$$

The symbol “≈” encompasses not only a case where both sides are completely the same as each other but also a case where both sides are substantially the same as each other. The expression “substantially the same” means that, for example, a case where (nx−ny)×d (in which d is a thickness of a film) is 0 to 10 nm and preferably 0 to 5 nm is also included in “nx≈ny”.

Examples of a feature point of the laminate according to the embodiment of the present invention include a point that a surface free energy of a surface of the light absorption anisotropic film and a surface free energy of a surface of the pressure-sensitive adhesive layer are adjusted such that a total of both is in a predetermined range.

The present inventors have conducted an investigation on the reason why the above-described problem of occurrence of color unevenness and deterioration of display performance in the display device occurs, and have found that adhesiveness between the light absorption anisotropic film and the pressure-sensitive adhesive layer affects the problem. More specifically, the present inventors have found that, in the display device including the laminate including the light absorption anisotropic film and the pressure-sensitive adhesive layer, the occurrence of the color unevenness is related to peeling between the light absorption anisotropic film and the pressure-sensitive adhesive layer. It is considered that, in a case of transporting the laminate including the light absorption anisotropic film and the pressure-sensitive adhesive layer, in a case of incorporating the laminate into the display device, or in a case of handling the laminate, peeling occurs at an interface between the light absorption anisotropic film and the pressure-sensitive adhesive layer, and as a result, the color unevenness of the display device is deteriorated.

Therefore, in the present invention, by adjusting the total of the surface free energy of the surface of the light absorption anisotropic film and the surface free energy of the surface of the pressure-sensitive adhesive layer, the peeling is less likely to occur, and as a result, the occurrence of the color unevenness in the display device is suppressed.

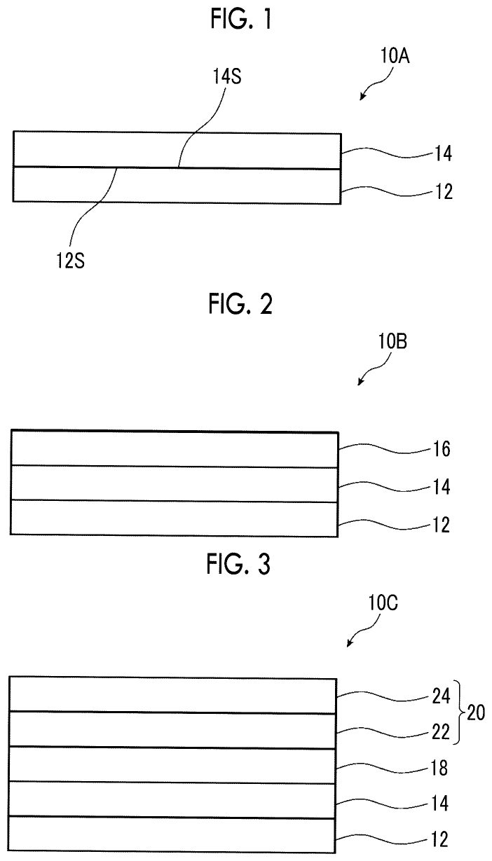

FIG. 1 shows an example of a laminate according to the embodiment of the present invention.

As shown in FIG. 1, a laminate 10A includes a light absorption anisotropic film 12 and a pressure-sensitive adhesive layer 14. As will be described later, the laminate 10A may include a member other than the light absorption anisotropic film 12 and the pressure-sensitive adhesive layer 14.

Hereinafter, first, a relationship between a surface free energy E1 of a surface 12S of the light absorption anisotropic film 12 on a pressure-sensitive adhesive layer 14 side and a surface free energy E2 of a surface 14S of the pressure-sensitive adhesive layer 14 on a light absorption anisotropic film 12 side will be described, and then each member will be described.

As shown in FIG. 1, the surface free energy of the surface 12S of the light absorption anisotropic film 12 on the pressure-sensitive adhesive layer 14 side is defined as a surface free energy E1, and the surface free energy of the surface 14S of the pressure-sensitive adhesive layer 14 on the light absorption anisotropic film 12 side is defined as a surface free energy E2. The total of the surface free energy E1 and the surface free energy E2 is 54.0 mNm⁻¹ or more. Among these, in a case where the laminate according to the embodiment of the present invention is applied to a display device (particularly, a virtual reality display device) and is visually recognized, from the viewpoint that the color unevenness is less likely to occur (hereinafter, also simply referred to as “the effect of the present invention is more excellent”), the total of the surface free energy E1 and the surface free energy E2 is preferably 70.0 mNm⁻¹ or more, and more preferably 80.0 mNm⁻¹ or more.

The upper limit of the total of the surface free energy E1 and the surface free energy E2 is not particularly limited, and is often 140.0 mNm⁻¹ or less. From the viewpoint that cracks are less likely to occur in the laminate, the upper limit is preferably 120.0 mNm⁻¹ or less, and more preferably 110.0 mNm⁻¹ or less.

A method of measuring the surface free energy is as follows.

The surface free energy is determined from contact angles θ_{H2O} and θ_{CH2I2} of pure water H₂O and methylene iodide CH₂I₂, respectively, which are actually measured with reference to D. K. Owens: J. Appl. Polym. Sci., 13, 1741 (1969), by the following simultaneous equations (A) and (B).

$$\begin{matrix}[ Simultaneous equations ] & \\ 1 + cos {θ}_{H 2 O} = 2 {( {γ}_{s}^{d} )}^{1 / 2} \{ {( {γ}_{H 2 O}^{d} )}^{1 / 2} / {γ}_{H 2 O}^{v} \} + 2 {( {γ}_{s}^{h} )}^{1 / 2} \{ {( {γ}_{H 2 O}^{h} )}^{1 / 2} / {γ}_{H 2 O}^{v} \} & ( A )\end{matrix}$$

$$1 + cos {θ}_{CH 2 I 2} = 2 {( {γ}_{s}^{d} )}^{1 / 2} \{ {( {γ}_{CH 2 I 2}^{d} )}^{1 / 2} / {γ}_{CH 2 I 2}^{v} \} + 2 {( {γ}_{s}^{h} )}^{1 / 2} \{ {( {γ}_{CH 2 I 2}^{h} )}^{1 / 2} / {γ}_{CH 2 I 2}^{v} \} \qquad ( B )$$

$${γ}_{H 2 O}^{d} = 29.1 , {γ}_{H 2 O}^{h} = 43.7 , {γ}_{H 2 O}^{v} = 72.8 ,$$

$${γ}_{CH 2 I 2}^{d} = 46.8 , {γ}_{CH 2 I 2}^{h} = 4. , {γ}_{CH 2 I 2}^{v} = 50.8$$

Here, in the above-described simultaneous equations, γₛ^{d} corresponds to a dispersion force component of the surface free energy, γₛ^{h} corresponds to a hydrogen bond component of the surface free energy, respectively, and a value γₛ^{v} (=γₛ^{d}+γₛ^{h}) represented by the sum thereof is defined as the surface free energy.

The measurement of the contact angle is carried out by carrying out conditioning of a sample for 24 hours under conditions of 25° C. and 60% using a contact angle meter (for example, DropMaster 500 manufactured by Kyowa Interface Science Co., Ltd.) and then adding 10 μl of pure water and 10 μl of methylene iodide dropwise onto the surface of the sample under the above-described conditions, and then carrying out the measurement after 30 seconds.

The magnitude of the surface free energy E1 is not particularly limited as long as the total of the surface free energy E1 and the surface free energy E2 is within a predetermined range, but is preferably 15.0 to 70.0 mNm⁻¹ and more preferably 20.0 to 60.0 mNm⁻¹. The magnitude of the surface free energy E2 is not particularly limited as long as the total of the surface free energy E1 and the surface free energy E2 is within a predetermined range, but is preferably 20.0 to 80.0 mNm⁻¹ and more preferably 30.0 to 70.0 mNm⁻¹.

A method of adjusting the total of the surface free energy E1 and the surface free energy E2 is not particularly limited, and a known method can be adopted.

Examples thereof include a method of adjusting the characteristics of the surfactant contained in the light absorption anisotropic film. Since the surfactant contained in the light absorption anisotropic film is likely to be unevenly distributed on the surface of the light absorption anisotropic film, the surface free energy E1 can be adjusted by adjusting the characteristics of the surfactant (for example, the Log P value of the surfactant), and as a result, the magnitude of the total of the surface free energy E1 and the surface free energy E2 can be adjusted.

In addition, the surface of the light absorption anisotropic film on the pressure-sensitive adhesive layer side is subjected to a surface activation treatment (for example, a corona treatment, a plasma treatment, or the like), and the surface free energy E1 can be adjusted, and as a result, the magnitude of the total of the surface free energy E1 and the surface free energy E2 can be adjusted.

In addition to the above, examples thereof include a method of adjusting the materials contained in the light absorption anisotropic film and the pressure-sensitive adhesive layer.

Hereinafter, each member of the laminate will be described in detail.

### [Light Absorption Anisotropic Film]

The light absorption anisotropic film can function as a linear polarizer which transmits linearly polarized light in a certain direction and absorbs linearly polarized light in a direction orthogonal to the linearly polarized light.

The light absorption anisotropic film contains an organic dichroic coloring agent.

The organic dichroic coloring agent means an organic coloring agent having different absorbances depending on the direction. In the light absorption anisotropic film, the organic dichroic coloring agent may be fixed.

The light absorption anisotropic film may contain only one kind of organic dichroic coloring agent or may contain a plurality of kinds of organic dichroic coloring agents.

Among these, from the viewpoint that the effect of the present invention is more excellent, it is preferable to contain four or more kinds of organic dichroic coloring agents. The upper limit of the number of kinds of organic dichroic coloring agents contained in the light absorption anisotropic film is not particularly limited, and is preferably 6 or less.

As the organic dichroic coloring agent, a dichroic azo coloring agent compound is preferable.

The dichroic azo coloring agent compound means an azo coloring agent compound having different absorbances depending on directions. The dichroic azo coloring agent compound may or may not exhibit liquid crystallinity. In a case where the dichroic azo coloring agent compound exhibits liquid crystallinity, any of nematic properties or smectic properties may be exhibited. The temperature range in which the liquid crystal phase is exhibited is preferably room temperature (approximately 20° C. to 28° C.) to 300° C., and from the viewpoint of handleability and manufacturing suitability, more preferably 50° C. to 200° C.

In the present invention, from the viewpoint of tint adjustment, it is preferable to use at least one coloring agent compound (hereinafter, also referred to as “first dichroic azo coloring agent compound”) having a maximal absorption wavelength in a wavelength range of 560 to 700 nm and at least one coloring agent compound (hereinafter, also referred to as “second dichroic azo coloring agent compound”) having a maximal absorption wavelength in a wavelength range of 455 nm or more and less than 560 nm.

In the present invention, three or more kinds of dichroic azo coloring agent compounds may be used in combination. For example, from the viewpoint of making color of the absorption polarizer close to black, it is preferable to use the first dichroic azo coloring agent compound, the second dichroic azo coloring agent compound, and at least one coloring agent compound having a maximal absorption wavelength in a wavelength range of 380 nm or more and less than 455 nm (hereinafter, also abbreviated as “third dichroic azo coloring agent compound”) in combination.

Among these, it is preferable to use at least one first dichroic azo coloring agent compound, at least one second dichroic azo coloring agent compound, and at least one third dichroic azo coloring agent compound, and to use a total of four or more kinds of the first dichroic azo coloring agent compound, the second dichroic azo coloring agent compound, and the third dichroic azo coloring agent compound.

Examples of the organic dichroic coloring agent which can be used in the present invention include those described in WO2018/186503A, WO2019/189345A, and WO2018/124198A.

A content of the organic dichroic coloring agent is preferably 1% by mass or more, more preferably 5% by mass or more, and still more preferably 10% by mass or more with respect to the total mass of the light absorption anisotropic film. The upper limit thereof is not particularly limited, but is preferably 30% by mass or less, more preferably 25% by mass or less, and still more preferably 20% by mass or less.

The light absorption anisotropic film preferably contains a liquid crystal compound and an organic dichroic coloring agent, and is preferably a light absorption anisotropic film which can be formed by applying a composition containing a liquid crystal compound and an organic dichroic coloring agent.

As the liquid crystal compound, both a polymer liquid crystal compound and a low-molecular-weight liquid crystal compound can be used, and from the viewpoint of increasing the alignment degree, a polymer liquid crystal compound is preferable. In addition, the polymer liquid crystal compound and the low-molecular-weight liquid crystal compound may be used in combination as the liquid crystal compound. The liquid crystal compound may be immobilized in the light absorption anisotropic film.

Here, the “polymer liquid crystal compound” denotes a liquid crystal compound having a repeating unit in the chemical structure.

In addition, the “low-molecular-weight liquid crystal compound” refers to a liquid crystal compound not including a repeating unit in a chemical structure.

The low-molecular-weight liquid crystal compound is not particularly limited, and examples thereof include a compound exhibiting a nematic liquid crystal phase and a compound exhibiting a smectic liquid crystal phase. From the viewpoint of increasing the alignment degree, a compound exhibiting a smectic liquid crystal phase is preferable. Examples thereof include liquid crystal compounds described in JP2013-228706A.

Examples of the polymer liquid crystal compound include thermotropic liquid crystal polymers described in JP2011-237513A.

In a case where the light absorption anisotropic film contains the polymer liquid crystal compound, it is preferable that the polymer liquid crystal compound forms a nematic liquid crystal phase. A temperature range at which the nematic liquid crystal phase is exhibited is preferably room temperature (23° C.) to 450° C., and more preferably 50° C. to 400° C. from the viewpoint of handleability and manufacturing suitability.

A content of the liquid crystal compound in the light absorption anisotropic film is preferably 25 to 2,000 parts by mass, more preferably 100 to 1,300 parts by mass, and still more preferably 200 to 900 parts by mass with respect to 100 parts by mass of the content of the organic dichroic coloring agent. In a case where the content of the liquid crystal compound is within the above-described range, the alignment degree of the organic dichroic coloring agent is further improved.

The light absorption anisotropic film may include one kind of a liquid crystal compound alone or may include two or more kinds of liquid crystal compounds. In a case of containing two or more kinds of liquid crystal compounds, the above-described content of the liquid crystal compound means the total content of the liquid crystal compounds.

The light absorption anisotropic film may contain a surfactant, an adhesion improver, a plasticizer, and the like, in addition to the above-described components.

The kind of the surfactant is not particularly limited, and a known surfactant can be used.

A Log P value of the surfactant is not particularly limited, but is usually 5.0 or less, and from the viewpoint that the effect of the present invention is more excellent, the Log P value of the surfactant is preferably 4.0 or less and more preferably 3.0 or less. A lower limit of the Log P value of the surfactant is not particularly limited, but is preferably 1.0 or more. Here, the Log P value is an index for expressing the properties of the hydrophilicity and hydrophobicity of a chemical structure and is also referred to as a hydrophilic-hydrophobic parameter. The Log P value can be calculated using software such as ChemBioDraw Ultra or HSPiP (Ver.4.1.07). Further, the Log P value can be acquired experimentally by the method of the OECD Guidelines for the Testing of Chemicals, Sections 1, Test No. 117 or the like. In the present invention, a value calculated by inputting the structural formula of a compound to HSPiP (Ver.4.1.07) is employed as the Log P value unless otherwise specified.

Examples of the surfactant include a fluorine (meth)acrylate-based polymer described in paragraphs 0018 to 0043 of JP2007-272185A, and a polymer having silicon described in paragraphs 0019 to 0073 of WO2023/054164A. The surfactant may be a compound other than these. The surfactant may be used singly or in combination of two or more kinds thereof.

In a case where the light absorption anisotropic film contains a surfactant, a content of the surfactant is preferably 0.01% to 10% by mass and more preferably 0.02% to 5% by mass with respect to the total solid content mass of the light absorption anisotropic film.

Examples of the adhesion improver include reactive additives described in paragraphs 0123 to 0129 of JP2019-091088A, and boronic acid monomers described in paragraphs 0015 to 0028 of WO2015/053359A.

In the light absorption anisotropic film, it is more preferable to align the organic dichroic coloring agent using the alignment of the liquid crystal compound. That is, the organic dichroic coloring agent can be aligned as desired by using the technique of the guest-host liquid crystal cell in association with the alignment of the host liquid crystal. Specifically, the light absorption anisotropic film can be produced by mixing the organic dichroic coloring agent as a guest and the liquid crystal compound as a host liquid crystal, aligning the host liquid crystal, aligning the organic dichroic coloring agent along the alignment of the liquid crystal molecules, and fixing the alignment state. Examples of the alignment direction of the organic dichroic coloring agent include a direction parallel to the surface of the light absorption anisotropic film.

A thickness of the light absorption anisotropic film is not particularly limited, but is usually 50.0 μm or less, and from the viewpoint that the effect of the present invention is more excellent, it is preferably 10.0 μm or less and more preferably 5.0 μm or less. The lower limit thereof is not particularly limited, but may be, for example, 0.1 μm or more.

### [Pressure-Sensitive Adhesive Layer]

Examples of a pressure-sensitive adhesive constituting the pressure-sensitive adhesive layer include a pressure-sensitive adhesive and an adhesive.

Examples of the pressure-sensitive adhesive include a rubber-based pressure-sensitive adhesive, an acrylic pressure-sensitive adhesive, a silicone-based pressure-sensitive adhesive, a urethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, and a cellulose-based pressure-sensitive adhesive; and an acrylic pressure-sensitive adhesive or a polyvinyl alcohol-based pressure-sensitive adhesive is preferable, and a polyvinyl alcohol-based pressure-sensitive adhesive is more preferable.

Examples of the adhesive include a water-based adhesive, a solvent-based adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet curable adhesive, and a visible light-curable adhesive; and among these, an ultraviolet curable adhesive is preferable.

A Log P value of the pressure-sensitive adhesive layer is not particularly limited, but is usually 1.5 or less, and from the viewpoint that the effect of the present invention is more excellent, it is preferably 0.5 or less. The lower limit of the Log P value of the pressure−sensitive adhesive layer is not particularly limited, but is usually −2.0 or more.

The Log P value of the pressure-sensitive adhesive layer is a weight-average value of Log P of each component contained in the pressure-sensitive adhesive layer. For example, in a case where the pressure-sensitive adhesive layer contains a component A having a Log P value of X and a content of 80% by mass with respect to the total mass of the pressure-sensitive adhesive layer, and a component B having a Log P value of Y and a content of 20% by mass with respect to the total mass of the pressure-sensitive adhesive layer, the Log P value of the pressure-sensitive adhesive layer is calculated as (X×0.8)+(Y×0.2).

A thickness of the pressure-sensitive adhesive layer is not particularly limited, but is usually 20 μm or less, and from the viewpoint that the effect of the present invention is more excellent, it is preferably 13.0 μm or less and more preferably 7.5 μm or less. The lower limit thereof is not particularly limited, but is usually 0.05 μm or more.

The laminate according to the embodiment of the present invention may include a member other than the above-described light absorption anisotropic film and pressure-sensitive adhesive layer.

The laminate according to the embodiment of the present invention may further include an adjacent layer disposed adjacent to the pressure-sensitive adhesive layer on a side of the pressure-sensitive adhesive layer opposite to the light absorption anisotropic film side. An elastic modulus of the adjacent layer is not particularly limited, but from the viewpoint that the effect of the present invention is more excellent, it is preferably 100 MPa or more and more preferably 500 MPa or more. The elastic modulus of the adjacent layer is not particularly limited, but is usually 20 GPa or less and more usually 10 GPa or less.

Examples of the adjacent layer include a retardation layer and a reflective polarizer, which will be described in detail later.

In addition, the elastic modulus refers to a value obtained by measuring an indentation elastic modulus of a surface of a test piece under the following conditions using a microhardness evaluation apparatus (for example, a nano tribo indenter TI-950 manufactured by Burker).

Indenter: triangular pyramid diamond indenter (Berkovich indenter, internal angle of indenter: 142.35°, angle between center line and surface: 65.35°)
Maximum indentation depth of indenter: 500 nm
Measurement temperature: 23° C.

In addition, the laminate may further include an alignment film disposed adjacent to the light absorption anisotropic film on a side opposite to the pressure-sensitive adhesive layer side of the light absorption anisotropic film. The alignment film may be provided to control the aligning properties in a case where the light absorption anisotropic film includes a liquid crystal compound.

The alignment film can be formed by methods such as rubbing treatment of an organic compound (preferably a polymer), oblique vapor deposition of an inorganic compound, formation of a layer having microgrooves, or accumulation of an organic compound (for example, ω-tricosanoic acid, dioctadecylmethylammonium chloride, or methyl stearate) by the Langmuir-Blodgett method (LB film).

Furthermore, there is also known an alignment film capable of expressing an orientation function by application of an electric field, application of a magnetic field, or light (preferably polarized light) irradiation.

As the alignment film, a photo-alignment film is preferable.

The photo-alignment film is a film containing a compound having a photo-aligned group, and is a film capable of applying an orientation restriction force by exposure.

Examples of the compound having a photo-aligned group include an azo compound, a cinnamate compound, a chalcone compound, and a coumarin compound.

A thickness of the alignment film is not particularly limited as long as the orientation function can be exhibited, but is preferably 0.01 to 5.0 μm and more preferably 0.05 to 2.0 μm.

FIG. 2 shows another example of the laminate according to the embodiment of the present invention.

As shown in FIG. 2, a laminate 10B includes a light absorption anisotropic film 12, a pressure-sensitive adhesive layer 14, and a retardation layer 16. Depending on the type of the retardation layer 16, the laminate 10B can be applied as a so-called circular polarization plate. The configurations of the light absorption anisotropic film 12 and the pressure-sensitive adhesive layer 14 are as described above.

Hereinafter, the configuration of the retardation layer will be described in detail.

### [Retardation Layer]

The laminate according to the embodiment of the present invention may include a retardation layer.

The type of the retardation layer is not particularly limited, and for example, the retardation layer may include a λ/4 plate.

The λ/4 plate is a plate having a λ/4 function, specifically, a plate having a function of converting linearly polarized light having a specific wavelength (preferably, visible light) into circularly polarized light (or converting circularly polarized light into linearly polarized light).

An in-plane retardation of the λ/4 plate at a wavelength of 550 nm is not particularly limited, but is preferably 120 to 150 nm, more preferably 125 to 145 nm, and still more preferably 135 to 140 nm.

In addition to the λ/4 plate, a retardation layer in which an in-plane retardation at a wavelength of 550 nm is 3/4 or 5/4 of a wavelength of any light of visible light is also preferable.

The retardation layer may have reverse wavelength dispersibility. The expression “having reverse wavelength dispersibility” denotes that as the wavelength increases, the value of the phase difference at the wavelength increases.

In addition, the retardation layer may have a multilayer structure, and specific examples thereof include a broadband λ/4 plate obtained by laminating a λ/4 plate and a V/2 plate.

An angle formed by an in-plane slow axis of the retardation layer and an absorption axis of the light absorption anisotropic film is not particularly limited, but is preferably within a range of 45°±10°.

The retardation layer may be a layer formed by immobilizing a liquid crystal compound twisted and aligned with a thickness direction as a helical axis. For example, a retardation layer having a layer formed by immobilizing a rod-like liquid crystal compound or a disk-like liquid crystal compound twisted and aligned with a thickness direction as a helical axis, as described in JP5753922B and JP5960743B, can be used.

The retardation layer may include a positive A plate.

An in-plane retardation of the positive A plate at a wavelength of 550 nm is not particularly limited, but is preferably 120 to 150 nm, more preferably 125 to 145 nm, and still more preferably 135 to 140 nm.

The positive A plate preferably functions as the above-described λ/4 plate.

The retardation layer may include a positive C-plate.

The positive C-plate is a retardation layer in which an in-plane retardation is substantially zero and a thickness-direction retardation has a negative value. The positive C-plate functions as an optical compensation layer for increasing the degree of polarization of the transmitted light with respect to light incident obliquely.

The in-plane retardation of the positive C-plate at a wavelength of 550 nm is preferably 10 nm or less.

The thickness-direction retardation of the positive C-plate at a wavelength of 550 nm is preferably −600 to −40 nm.

A material constituting the retardation layer is not particularly limited, but is preferably formed of a composition including a liquid crystal compound. Such a retardation layer can be typically obtained by vertically aligning a rod-like polymerizable liquid crystal compound included in a polymerizable liquid crystal composition and fixing an alignment state by polymerization. In addition, the retardation layer can also be formed of a composition containing the side chain-type polymer liquid crystal compound as the liquid crystal compound.

A thickness of the retardation layer is not particularly limited, but is preferably 0.1 to 8 m and more preferably 0.3 to 5 μm.

FIG. 3 shows another example of the laminate according to the embodiment of the present invention.

As shown in FIG. 3, a laminate 10C includes a light absorption anisotropic film 12, a pressure-sensitive adhesive layer 14, a reflective polarizer 18, and a retardation layer 20. The retardation layer 20 includes a positive A plate 22 and a positive C-plate 24. The laminate 10C can be applied as a member of a virtual reality display device described later.

The configurations of the light absorption anisotropic film 12 and the pressure-sensitive adhesive layer 14 are as described above.

Examples of the configurations of the positive A plate 22 and the positive C-plate 24 included in the retardation layer 20 include the configurations described in the retardation layer included in the laminate 10B in FIG. 2 described above.

Hereinafter, the configuration of the reflective polarizer 18 will be described in detail.

### [Reflective Polarizer]

The reflective polarizer (reflective linear polarizer) is a linear polarizer which transmits linearly polarized light in a certain direction and reflects linearly polarized light in a direction orthogonal to the linearly polarized light.

As the reflective polarizer, a known reflective polarizer (reflective linear polarizer) can be used as long as it selectively transmits linearly polarized light in a certain direction in a wavelength range of visible light.

Examples of the reflective polarizer include a film obtained by stretching a dielectric multi-layer film as described in JP2011-053705A, and a wire grid type polarizer.

In addition, a commercially available product can also be suitably used as the reflective polarizer. Examples of the commercially available reflective polarizer include a reflective polarizer (trade name: APF) manufactured by 3M and a wire grid type polarizer (trade name: WGF) manufactured by AGC Inc.

### [Other Members]

The laminate according to the embodiment of the present invention may include a member other than the above-described various members. The other members are not particularly limited, and examples thereof include a pressure-sensitive adhesive layer other than the pressure-sensitive adhesive layer disposed adjacent to the light absorption anisotropic film, an antireflection layer on the surface, and a support.

### <Other Pressure-Sensitive Adhesive Layer>

The laminate according to the embodiment of the present invention may include a pressure-sensitive adhesive layer other than the pressure-sensitive adhesive layer disposed adjacent to the light absorption anisotropic film in order to enhance the adhesiveness between the members.

Examples of the configuration of the other pressure-sensitive adhesive layer include a configuration of a pressure-sensitive adhesive layer disposed adjacent to the light absorption anisotropic film.

### <Surface Antireflection Layer>

The laminate according to the embodiment of the present invention may include an antireflection layer on the surface.

In the laminate according to the embodiment of the present invention, the surface antireflection layer is preferably disposed on the outermost surface side. The surface antireflection layer may be disposed only on one surface side of the laminate, or may be disposed on both surface sides of the laminate.

The type of the surface antireflection layer is not particularly limited, but from the viewpoint of further decreasing the reflectivity, a moth-eye film or an anti reflection (AR) film is preferable. In addition, since the antireflection property can be maintained even in a case where the film thickness fluctuates due to stretching and forming, a moth-eye film is preferable.

### <Support>

The laminate according to the embodiment of the present invention may include a support.

The type of the support is not particularly limited, but it is preferable that the support is transparent, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, as the support, a cellulose acylate film, a cyclic polyolefin film, a polyacrylate film, or a polymethacrylate film is preferable. In addition, commercially available cellulose acetate films (for example, “TD80U” or “Z-TAC” manufactured by FUJIFILM Corporation) can also be used.

In addition, it is preferable that the support has a small phase difference. Specifically, an in-plane retardation at a wavelength of 550 nm is preferably 10 nm or less, and an absolute value of the thickness-direction retardation at a wavelength of 550 nm is preferably 50 nm or less.

The thickness of the support is not particularly limited, but is preferably 5 to 300 m and more preferably 5 to 100 μm.

The laminate according to the embodiment of the present invention may have a non-planar shape (for example, a curved surface structure) in a part of the structure.

### [Method for Producing Laminate]

The above-described manufacturing method of a laminate is not particularly limited, and a known method can be adopted.

As described above, in order to adjust the surface free energy E1 and the surface free energy E2, a surface activation treatment may be performed on the surface of the light absorption anisotropic film before providing the pressure-sensitive adhesive layer on the light absorption anisotropic film.

Examples of the surface activation treatment include a corona treatment and a plasma treatment. The conditions of the treatment are selected according to the materials to be used.

Examples of the manufacturing method of the laminate according to the embodiment of the present invention include a method of manufacturing a light absorption anisotropic film and then providing a pressure-sensitive adhesive layer on the surface of the light absorption anisotropic film.

Examples of the method of manufacturing a light absorption anisotropic film include an aspect including the following steps 1 to 3.
Step 1: step of forming an alignment film on a support
Step 2: step of applying a composition containing a liquid crystal compound and an organic dichroic coloring agent onto the alignment film obtained in the step 1, and aligning the liquid crystal compound to obtain a light absorption anisotropic film
Step 3: step of forming a pressure-sensitive adhesive layer on a surface of the light absorption anisotropic film to obtain a laminate

Hereinafter, the procedure of the steps will be specifically described.

The step 1 is a step of forming an alignment film on a support.

The support and the alignment film to be used are as described above. Among these, a photo-alignment film is preferable as the alignment film.

The procedure of forming a photo-alignment film on a support is not particularly limited, and examples thereof include a method of applying a composition containing a photo-alignment material onto a support to form a coating film, and irradiating the obtained coating film with polarized light.

The step 2 is a step of applying a composition containing a liquid crystal compound and an organic dichroic coloring agent onto the alignment film obtained in the step 1, and aligning the liquid crystal compound to obtain a light absorption anisotropic film.

The liquid crystal compound and the organic dichroic coloring agent used in the composition are as described above.

The composition may further contain a solvent.

In a case where at least one of the liquid crystal compound or the organic dichroic coloring agent has a polymerizable group, the composition may further contain a polymerization initiator.

Examples of the method of applying the composition include known methods such as a roll coating method, a gravure printing method, a spin coating method, a wire bar coating method, an extrusion coating method, a direct gravure coating method, a reverse gravure coating method, a die-coating method, a spraying method, and an ink jet method.

Next, a treatment of aligning the liquid crystal compound in the coating film is performed.

The alignment treatment may include a drying treatment. The drying treatment makes it possible to remove components such as a solvent from the coating film. The drying treatment may be performed by a method of allowing the coating film to stand at room temperature for a predetermined time (for example, natural drying) or a method of heating the coating film and/or blowing air to the coating film.

It is preferable that the alignment treatment includes a heat treatment. As a result, the liquid crystal compound contained in the coating film can be aligned.

From the viewpoint of manufacturing suitability and the like, the heat treatment is preferably performed at 35° C. to 250° C. and more preferably at 45° C. to 190° C. In addition, the heating time is preferably 1 to 300 seconds and more preferably 1 to 60 seconds.

The alignment treatment may include a cooling treatment performed after the heat treatment. The cooling treatment is a treatment of cooling the coating film after the heating. In this manner, the alignment of the liquid crystal compound contained in the coating film can be fixed. The cooling unit is not particularly limited, and the cooling can be performed by a known method. As the cooling temperature, the optimum temperature is selected depending on the liquid crystal compound used.

In a case where the liquid crystal compound has a polymerizable group, a curing treatment may be performed as necessary. Examples of the curing treatment include a light irradiation treatment.

The step 3 is a step of forming a pressure-sensitive adhesive layer on a surface of the light absorption anisotropic film to obtain a laminate.

A method of forming the pressure-sensitive adhesive layer on the surface of the light absorption anisotropic film is not particularly limited, and examples thereof include a method of bonding the pressure-sensitive adhesive layer to the surface of the light absorption anisotropic film and a method of applying a composition for forming a pressure-sensitive adhesive layer onto the surface of the light absorption anisotropic film to form the pressure-sensitive adhesive layer.

In order to impart a curved shape to the laminate, various forming treatments may be performed on the laminate as necessary.

### [Composite Lens]

The composite lens according to the embodiment of the present invention includes the above-described laminate, a lens, and a half mirror.

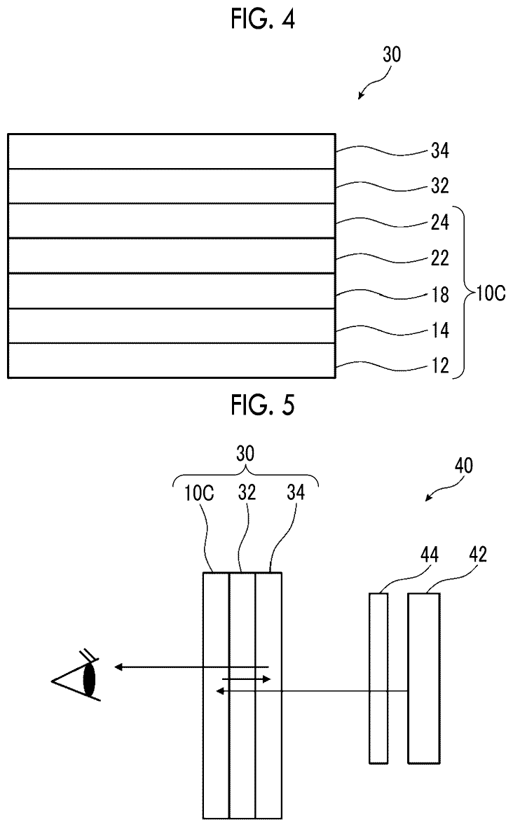

FIG. 4 shows an example of the composite lens according to the embodiment of the present invention.

A composite lens 30 includes a laminate 10C, a lens 32, and a half mirror 34 in this order.

The configuration of the laminate 10C is as described above.

Hereinafter, members other than the laminate, included in the composite lens, will be described in detail.

### <Lens>

The composite lens includes a lens.

Examples of the lens include a convex lens and a concave lens.

Examples of the convex lens include a biconvex lens, a plano-convex lens, and a convex meniscus lens. Examples of the concave lens include a biconcave lens, a plano-concave lens, and a concave meniscus lens.

As the lens used in the virtual reality display device, a convex meniscus lens or a concave meniscus lens is preferable from the viewpoint of enlarging the angle of view, and a concave meniscus lens is more preferable from the viewpoint that chromatic aberration can be further suppressed.

As a material of the lens, a material transparent to visible light, such as glass, crystal, and plastic, can be used. Since the birefringence of the lens causes rainbow-like unevenness or light leakage, it is preferable that the birefringence is small, and a material having zero birefringence is more preferable.

### <Half Mirror>

The composite lens according to the embodiment of the present invention includes a half mirror. The half mirror is a well-known half mirror in the related art that allows transmission of about half of incident light and reflects the remaining half of the incident light.

The transmittance of the half mirror is preferably 50±30% and more preferably 50±10%.

The type of the half mirror is not particularly limited, and examples thereof include a reflective layer consisting of a metal. Examples of the metal include silver and aluminum.

A thickness of the half mirror is preferably 1 to 20 nm, more preferably 2 to 10 nm, and still more preferably 3 to 6 nm.

### [Display Device (Virtual Reality Display Device)]

The laminate according to the embodiment of the present invention can be applied to various display devices, and is preferably applied to a virtual reality display device.

FIG. 5 is a schematic view showing an example of a configuration of the virtual reality display device.

A virtual reality display device 40 shown in FIG. 5 includes an image display panel 42, a circular polarization plate 44, and a composite lens 30 from a right side in the drawing. The composite lens 30 used in FIG. 5 has the same configuration as the composite lens 30 shown in FIG. 4.

In the virtual reality display device 40 shown in FIG. 5, a ray emitted from an image display panel 42 is transmitted through a circular polarization plate 44 to be circularly polarized light, and is transmitted through a half mirror 34. Next, the light passes through the positive A plate included in the laminate 10C to be converted into linearly polarized light, and is incident from a reflective polarizer side included in the laminate 10C and reflected. The light reflected by the reflective polarizer passes through the positive A plate to be converted into circularly polarized light, is reflected by the half mirror 34, passes through the positive A plate again to be converted into linearly polarized light, and is incident on the reflective polarizer again. In this case, the polarization state of the ray incident on the reflective polarizer again does not change in a case of being reflected by the reflective polarizer, and is changed to linearly polarized light orthogonal to the linearly polarized light in a case of being incident on the reflective polarizer for the first time, in a case of being reflected by the half mirror 34 and passing through the positive A plate. Therefore, the ray is transmitted through the reflective polarizer and is visible to a user.

The image display panel 42 is, for example, a known image display panel (display panel) such as an organic electroluminescence display panel.

In the example shown in the drawing, the image display panel 42 emits an image (image light) of unpolarized light. The unpolarized image emitted from the image display panel 42 passes through the circular polarization plate 44, and is converted into circularly polarized light.

### EXAMPLES

Hereinafter, the features of the present invention will be described in more detail with reference to Examples. Materials, used amounts, ratios, treatment details, treatment procedures, and the like shown below can be appropriately changed within a range not departing from the scope of the present invention. In addition, configurations other than the configurations described below can be employed without departing from the gist of the present invention.

### [Production of Light Absorption Anisotropic Film C1]

### <Preparation of Support>

The following composition was put into a mixing tank, stirred, and further heated at 90° C. for 10 minutes. Thereafter, the obtained composition was filtered through a filter paper having an average hole diameter of 34 μm and a sintered metal filter having an average hole diameter of 10 μm to prepare a dope. The concentration of solid contents of the dope was 23.5% by mass, the addition amount of the plasticizer was the ratio to the cellulose acylate, and the solvent of the dope was methylene chloride/methanol/butanol=81/18/1 (mass ratio).

Cellulose acylate dope

| | |
|---|---|
| Cellulose acylate | 100 parts by mass |
| (acetyl substitution degree of 2.86, viscosity average polymerization degree of 310): | |
| Sugar ester compound 1 (Formula (S4) shown below) | 6.0 parts by mass |
| Sugar ester compound 2 (Formula (S5) shown below) | 2.0 parts by mass |
| Silica particle dispersion liquid | 0.1 parts by mass |
| (AEROSIL R972, manufactured by Nippon Aerosil Co., Ltd.): | |
| Solvent (methylene chloride/methanol/butanol) | 351.9 parts by mass |

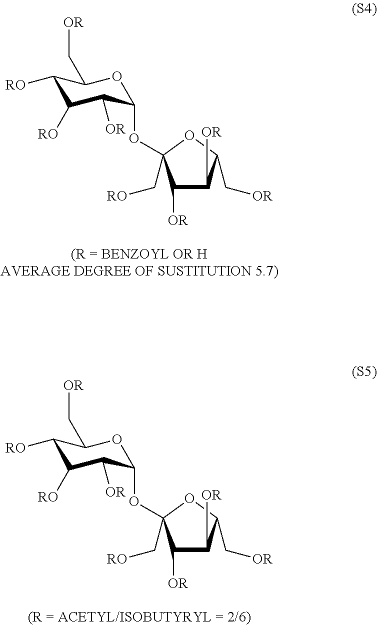

The produced dope above was cast using a drum film-forming machine. The dope was cast from a die such that it was in contact with a metal support cooled to 0° C., and then the obtained web (film) was stripped from the drum. The drum was made of stainless steel (SUS).

The web (film) obtained by casting was peeled off from the drum and dried in a tentering machine for 20 minutes using a tentering machine such that both ends of the web were clipped with clips and transported at 30° C. to 40° C. during film transport. Subsequently, the web was post-dried by zone heating while being rolled and transported. The obtained web was subjected to knurling and then wound to obtain a cellulose acylate film A1. The film thickness of the obtained cellulose acylate film A1 was 60 μm, the in-plane retardation Re (550) at a wavelength of 550 nm was 1 nm, and the retardation Rth (550) at a wavelength of 550 nm in the thickness direction was 35 nm.

### <Formation of Photo-Alignment Film B1>

The above-described cellulose acylate film A1 was continuously coated with a composition B1 for forming a photo-alignment film described below with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film B1, thereby obtaining a triacetyl cellulose (TAC) film with the photo-alignment film. A film thickness of the photo-alignment film B1 was 1.5 μm.

Formulation of composition B1 for forming photo-alignment film

| | |
|---|---|
| The following photo-alignment compound PA-1 | 100.00 parts by mass |
| EPICLON N-695 (manufactured by DIC Corporation) | 55.74 parts by mass |
| jER YX7400 (manufactured by Mitsubishi Chemical Corporation) | 18.75 parts by mass |
| Polymerizable polymer PA-2 shown below | 8.01 parts by mass |
| Thermal cationic polymerization initiator PAG-1 shown below | 16.75 parts by mass |
| Stabilizer DIPEA shown below | 1.06 parts by mass |
| Butyl acetate | 1230.49 parts by mass |

### Photo-Alignment Compound PA-1

(in the formula, the numerical value described in each repeating unit denotes the content (% by mass) of each repetition with respect to all repeating units; weight-average molecular weight: 32,000)

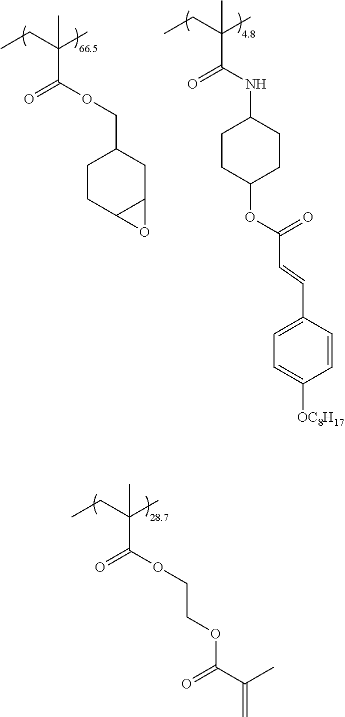

### Polymerizable Polymer PA-2

[in the formula, numerical values of a, b, and c represent the content (% by mass) of each repetition with respect to all the repeating units); weight-average molecular weight: 18,000]

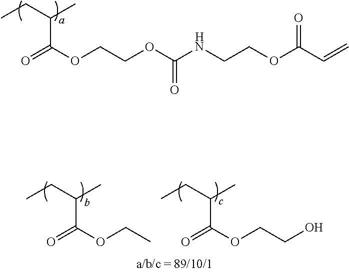

### Thermal Cationic Polymerization Initiator PAG-1

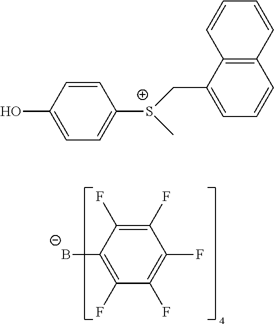

### Stabilizer DIPEA

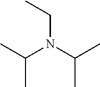

### <Formation of Light Absorption Anisotropic Film C1>

A coating film was formed by coating the obtained photo-alignment film B1 with a composition C1 for forming a light absorption anisotropic film, having the following formulation, with a wire bar.

Next, the coating film was heated at 140° C. for 15 seconds (first heating step), and then heated at 80° C. for 5 seconds, and the coating film was cooled to room temperature (25° C.).

Next, the coating film was heated at 75° C. for 15 seconds (second heating step), and then cooled to room temperature again.

Thereafter, the coating film was irradiated with a light emitting diode (LED) lamp (central wavelength: 365 nm) under an irradiation condition of an irradiance of 200 mW/cm² for 2 seconds, thereby producing a light absorption anisotropic film (polarizer) C1 having a thickness of 1.0 μm on the photo-alignment film B1.

In a case where a transmittance of the light absorption anisotropic film C1 in a wavelength range of 380 to 780 nm was measured with a spectrophotometer, the average transmittance of visible light was 43%.

The absorption axis of the light absorption anisotropic film C1 was in the plane of the light absorption anisotropic film C1, and was orthogonal to a width direction of the cellulose acylate film A1.

Composition C1 for forming light absorption anisotropic film

| | |
|---|---|
| Organic dichroic coloring agent Dye-Y1 shown below | 0.013 parts by mass |
| Organic dichroic coloring agent Dye-M1 shown below | 0.08 parts by mass |
| Organic dichroic coloring agent Dye-C1 shown below | 0.08 parts by mass |
| Organic dichroic coloring agent Dye-C2 shown below | 0.25 parts by mass |
| Liquid crystal compound L-1 shown below | 1.43 parts by mass |
| Liquid crystal compound L-2 shown below | 0.61 parts by mass |
| Adhesion improver A-1 shown below | 0.04 parts by mass |
| Polymerization initiator | 0.08 parts by mass |
| IRGACURE OXE-02 (manufactured by BASF SE) | |
| Surfactant F-1 shown below | 0.007 parts by mass |
| Cyclopentanone | 94.96 parts by mass |
| Benzyl alcohol | 2.43 parts by mass |

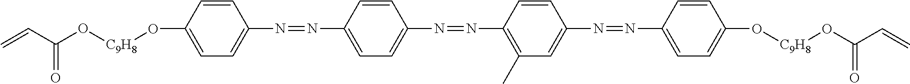

### Organic Dichroic Coloring Agent Dye-Y1

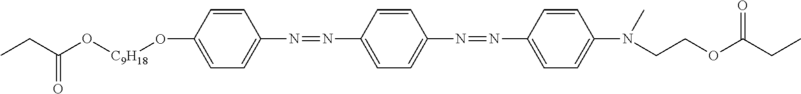

Organic dichroic coloring agent Dye-C2

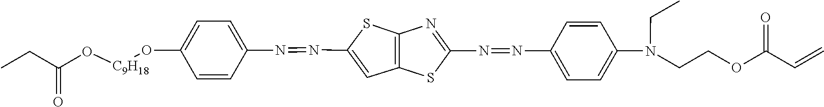

### Liquid Crystal Compound L-1

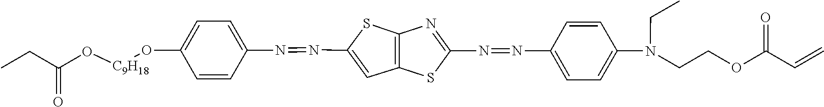

[in the formula, the numerical values (“59”, “15”, and “26”) described in each repeating unit denote the content (% by mass) of each repetition with respect to all repeating units; weight-average molecular weight: 18,000]

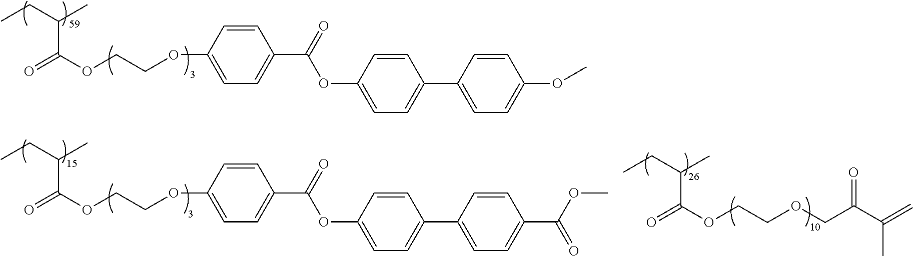

### Liquid Crystal Compound L-2

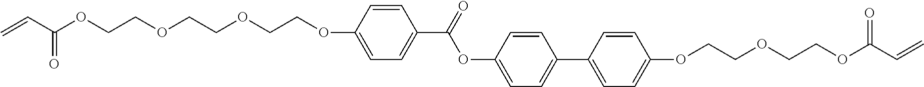 [SMILES: C=CC(=O)OCCOCCOCCOc1ccc(C(=O)Oc2ccc(-c3ccc(OCCOCCOC(=O)C=C)cc3)cc2)cc1]

### Adhesion Improver A-1

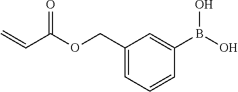

### Surfactant F-1

[in the formula, the numerical value described in each repeating unit denotes the content (% by mass) of each repetition with respect to all repeating units; Weight-average molecular weight: 16,000]

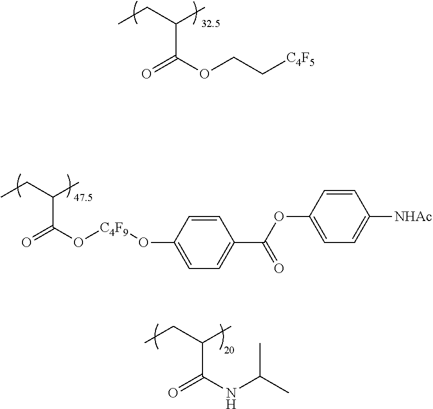

### [Production of Light Absorption Anisotropic Film C2]

A light absorption anisotropic film C2 was produced by the same method as in [Production of light absorption anisotropic film C1], except that the following composition C2 for forming a light absorption anisotropic film was used instead of the composition C1 for forming a light absorption anisotropic film.

Composition C2 for forming light absorption anisotropic film

| | |
|---|---|
| Organic dichroic coloring agent Dye-Y1 shown above | 0.013 parts by mass |
| Organic dichroic coloring agent Dye-M1 shown above | 0.08 parts by mass |
| Organic dichroic coloring agent Dye-C1 shown above | 0.08 parts by mass |
| Organic dichroic coloring agent Dye-C2 shown above | 0.25 parts by mass |
| Liquid crystal compound L-1 shown above | 1.43 parts by mass |
| Liquid crystal compound L-2 shown above | 0.61 parts by mass |
| The above-described adhesion improver A-1 | 0.04 parts by mass |
| Polymerization initiator | 0.08 parts by mass |
| IRGACURE OXE-02 (manufactured by BASF SE) | |
| Surfactant F-2 shown below | 0.007 parts by mass |
| Cyclopentanone | 94.96 parts by mass |
| Benzyl alcohol | 2.43 parts by mass |

### Surfactant F-2

[in the formula, the numerical value described in each repeating unit denotes the content (% by mass) of each repetition with respect to all repeating units; weight-average molecular weight: 15,000]

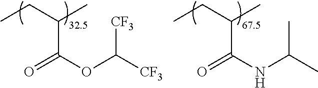

### [Production of Light Absorption Anisotropic Film C3]

A light absorption anisotropic film C3 was produced by the same method as in [Production of light absorption anisotropic film C1], except that the following composition C3 for forming a light absorption anisotropic film was used instead of the composition C1 for forming a light absorption anisotropic film.

Composition C3 for forming light absorption anisotropic film

| | |
|---|---|
| Organic dichroic coloring agent Dye-Y1 shown above | 0.013 parts by mass |
| Organic dichroic coloring agent Dye-M1 shown above | 0.08 parts by mass |
| Organic dichroic coloring agent Dye-C1 shown above | 0.08 parts by mass |
| Organic dichroic coloring agent Dye-C2 shown above | 0.25 parts by mass |
| Liquid crystal compound L-1 shown above | 1.43 parts by mass |
| Liquid crystal compound L-2 shown above | 0.61 parts by mass |
| The above-described adhesion improver A-1 | 0.04 parts by mass |
| Polymerization initiator | 0.08 parts by mass |
| IRGACURE OXE-02 (manufactured by BASF SE) | |
| Surfactant F-3 shown below | 0.007 parts by mass |
| Cyclopentanone | 94.96 parts by mass |
| Benzyl alcohol | 2.43 parts by mass |

### Surfactant F-3

[in the formula, the numerical value described in each repeating unit denotes the content (% by mass) of each repetition with respect to all repeating units; weight-average molecular weight: 15,000]

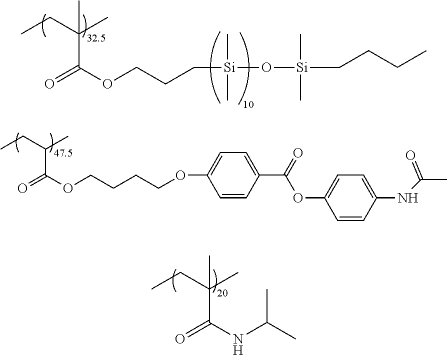

### [Production of Light Absorption Anisotropic Film C4]

A light absorption anisotropic film C4 was produced in the same manner as in [Production of light absorption anisotropic film C1], except that the following composition C4 for forming a light absorption anisotropic film was used instead of the composition C1 for forming a light absorption anisotropic film.

Composition C4 for forming light absorption anisotropic film

| | |
|---|---|
| Organic dichroic coloring agent Dye-Y1 shown above | 0.013 parts by mass |
| Organic dichroic coloring agent Dye-M1 shown above | 0.08 parts by mass |
| Organic dichroic coloring agent Dye-C1 shown above | 0.33 parts by mass |
| Liquid crystal compound L-1 shown above | 1.43 parts by mass |
| Liquid crystal compound L-2 shown above | 0.61 parts by mass |
| The above-described adhesion improver A-1 | 0.04 parts by mass |
| Polymerization initiator | 0.08 parts by mass |
| IRGACURE OXE-02 (manufactured by BASF SE) | |
| Surfactant F-1 shown above: | 0.007 parts by mass |
| Cyclopentanone | 94.96 parts by mass |
| Benzyl alcohol | 2.43 parts by mass |

### Production of light absorption anisotropic file C5

A light absorption anisotropic file C5 was produced in the same manner as in [Production of light absorption anisotropic file C1], except that the following composition C5 for forming a light absorption anisotropic film was used instead of the composition C1 for forming a ligh absorption anisotropic film.

Composition C5 for forming light absorption anisotropic film

| | |
|---|---|
| Organic dichroic coloring agent Dye-Y1 shown above | 0.013 parts by mass |
| Organic dichroic coloring agent Dye-M1 shown above | 0.08 parts by mass |
| Organic dichroic coloring agent Dye-C1 shown above | 0.08 parts by mass |
| Organic dichroic coloring agent Dye-C2 shown above | 0.25 parts by mass |
| Liquid crystal compound L-3 shown below | 1.53 parts by mass |
| Liquid crystal compound L-4 shown below | 0.51 parts by mass |
| The above-described adhesion improver A-1 | 0.04 parts by mass |
| Polymerization initiator | 0.08 parts by mass |
| IRGACURE OXE-02 (manufactured by BASF SE) | |
| Surfactant F-1 shown above: | 0.007 parts by mass |
| Cyclopentanone | 94.96 parts by mass |
| Benzyl alcohol | 2.43 parts by mass |

### Liquid Crystal Compound L-3

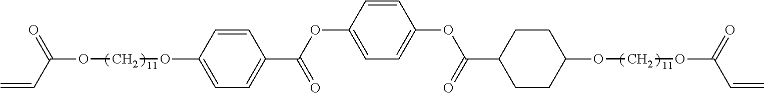

Liquid Crystal Compound L-4

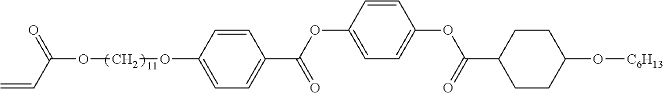

### [Production of Light Absorption Anisotropic Film C6]

An integrated absorption-reflective polarizer corresponding to the light absorption anisotropic film C6 was produced according to the description in paragraphs 0031 and 0032 of JP2018-521349A.

### Example 1 (Production of Laminate and Composite Lens)

### <Production of Retardation Layer Film 1 Including Positive A-Plate>

The above-described cellulose acylate film A1 was continuously coated with a coating liquid E1 for forming a photo-alignment film, having the following formulation, with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film E1 having a thickness of 0.2 μm, thereby obtaining a TAC film with the photo-alignment film.

Coating liquid E1 for forming photo-alignment film

| | |
|---|---|
| Polymer PA-3 shown below | 100.00 parts by mass |
| Thermal cationic polymerization initiator PAG-1 shown above | 5.00 parts by mass |
| Acid generator CPI-110TF shown below | 0.005 parts by mass |
| Isopropyl alcohol | 16.50 parts by mass |
| Butyl acetate | 1072.00 parts by mass |
| Methyl ethyl ketone | 268.00 parts by mass |

Polymer PA-3 [in the formula, the numerical value described in each repeating unit denotes the content (% by mass) of each repetition with respect to all repeating units; weight-average molecular weight: 45,000]

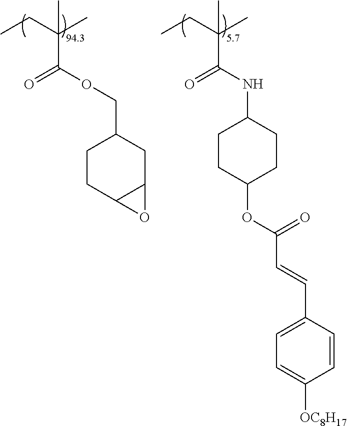

### Acid Generator CPI-110TF

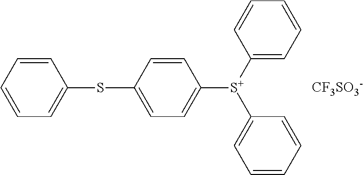

The above-described photo-alignment film E1 was coated with a composition F1 having the following formulation with a bar coater. The coating film formed on the photo-alignment film E1 was heated to 120° C. with hot air, cooled to 60° C., irradiated with ultraviolet rays having a wavelength of 365 nm with an irradiance of 100 mJ/cm² using a high-pressure mercury lamp in a nitrogen atmosphere, and continuously irradiated with ultraviolet rays with an irradiance of 500 mJ/cm² while being heated at 120° C., so that the alignment of the liquid crystal compound was immobilized, thereby producing a retardation layer film 1 including a positive A-plate F1.

The thickness of the positive A-plate F1 was 2.5 μm, and the Re (550) was 144 nm. In addition, the positive A plate satisfied a relationship of “Re(450)≤Re(550)≤Re(650)”. Re(450)/Re(550) was 0.82. The above-described positive A-plate corresponds to a so-called λ/4 plate.

Composition F1

| | |
|---|---|
| Polymerizable liquid crystal compound LA-1 shown below | 43.50 parts by mass |
| Polymerizable liquid crystal compound LA-2 shown below | 43.50 parts by mass |
| Polymerizable liquid crystal compound LA-3 shown below | 8.00 parts by mass |
| Polymerizable liquid crystal compound LA-4 shown below | 5.00 parts by mass |
| Polymerization initiator PI-1 shown below | 0.55 parts by mass |
| Leveling agent T-1: | 0.20 parts by mass |
| Cyclopentanone | 235.00 parts by mass |

### Polymerizable Liquid Crystal Compound LA-1 (tBu Represents Tertiary Butyl Group)

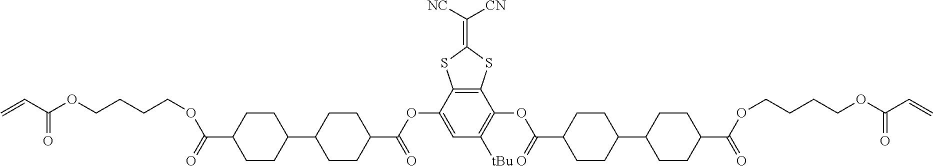 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]

Polymerizable liquid crystal compound LA-2

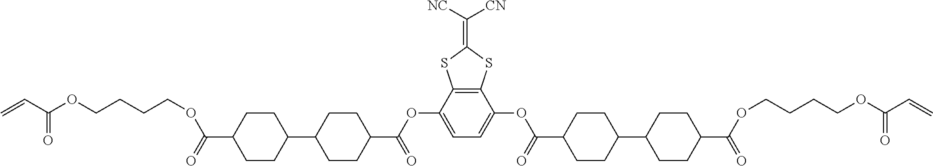 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]

### Polymerizable Liquid Crystal Compound LA-3

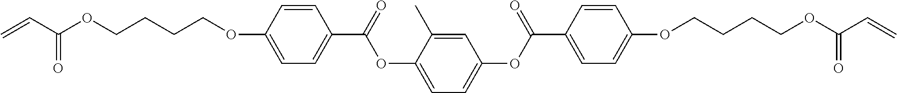 [SMILES: C=CC(=O)OCCCCOc1ccc(C(=O)Oc2ccc(OC(=O)c3ccc(OCCCCOC(=O)C=C)cc3)c(C)c2)cc1]

### Polymerizable Liquid Crystal Compound LA-4 (Me Represents a Methyl Group)

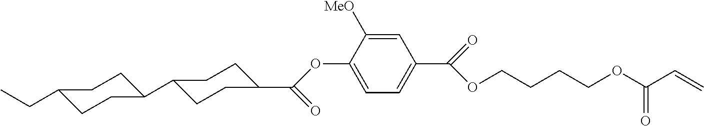 [SMILES: C=CC(=O)OCCCCOC(=O)c1ccc(OC(=O)C2CCC(C3CCC(CC)CC3)CC2)c(OC)c1]

### Polymerization Initiator PI-1

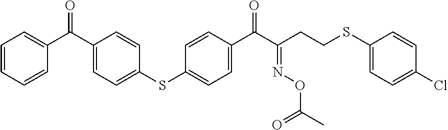 [SMILES: CC(=O)O/N=C(\CCSc1ccc(Cl)cc1)C(=O)c1ccc(Sc2ccc(C(=O)c3ccccc3)cc2)cc1]

Leveling agent T-1 [in the formula, the numerical value described in each repeating unit denotes the content (% by mass) of each repetition with respect to all repeating units; weight-average molecular weight: 25,000]

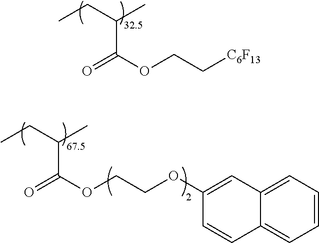

### <Production of Retardation Layer Film 2 Including Positive C-Plate>

The above-described cellulose acylate film A1 was used as a temporary support.

After passing the cellulose acylate film A1 through a dielectric heating roll at a temperature of 60° C. to raise the film surface temperature to 40° C., an alkaline solution having the formulation shown below was applied onto one surface of the film using a bar coater at a coating amount of 14 ml/m², followed by heating to 110° C., and transportation of the film under a steam type far-infrared heater manufactured by Noritake Company Limited for 10 seconds.

Next, the film was coated with pure water such that the coating amount reached 3 ml/m² using the same bar coater. Next, the film was washed with water by a fountain coater and drained by an air knife three times, and then transported to a drying zone at 70° C. for 10 seconds and dried to produce a cellulose acylate film A1 subjected to an alkali saponification treatment.

(Alkaline solution)

| | |
|---|---|
| Potassium hydroxide | 4.7 parts by mass |
| Water | 15.8 parts by mass |
| Isopropanol | 63.7 parts by mass |
| Fluorine-containing surfactant SF-1 | 1.0 part by mass |
| (C₁₄H₂₉O(CH₂CH₂O)₂₀H) | |
| Propylene glycol | 14.8 parts by mass |

The cellulose acylate film A1 which had been subjected to the alkali saponification treatment was continuously coated with a coating liquid G1 for forming an alignment film, having the following formulation, using a #8 wire bar. The obtained film was dried with hot air at 60° C. for 60 seconds, and further dried with hot air at 100° C. for 120 seconds to form an alignment film G1.

Coating liquid G1 for forming alignment film

| | |
|---|---|
| Polyvinyl alcohol | 2.4 parts by mass |
| (PVA103, manufactured by Kuraray Co., Ltd.): | |
| Isopropyl alcohol: | 1.6 parts by mass |
| Methanol: | 36 parts by mass |
| Water: | 60 parts by mass |

The alignment film G1 was coated with a coating liquid H1 for forming a positive C-plate, having the following formulation, the obtained coating film was aged at 60° C. for 60 seconds and irradiated with ultraviolet rays at an irradiance of 1000 mJ/cm² in the air using an air-cooled metal halide lamp at an irradiance of 70 mW/cm² (manufactured by Eye Graphics Co., Ltd.), and the alignment state thereof was fixed to vertically align the liquid crystal compound, thereby producing a retardation layer film 2 including a positive C-plate H1 with a thickness of 0.5 μm.

The Rth (550) of the obtained positive C-plate was −60 nm.

Coating liquid H1 for forming positive C-plate

| | |
|---|---|
| Liquid crystal compound LC-1 shown below | 80 parts by mass |
| Liquid crystal compound LC-2 shown below | 20 parts by mass |
| Vertically aligned liquid crystal compound alignment agent S01 shown below | 1 part by mass |
| Ethylene oxide-modified trimethylolpropane triacrylate | 8 parts by mass |
| (V#360, manufactured by Osaka Organic Chemical Industry Ltd.): | |
| IRGACURE 907 (manufactured by BASF SE): | 3 parts by mass |
| KAYACURE DETX (manufactured by Nippon Kayaku Co., Ltd.): | 1 part by mass |
| Compound B03 shown below: | 0.4 parts by mass |
| Methyl ethyl ketone: | 170 parts by mass |
| Cyclohexanone: | 30 parts by mass |

### Liquid Crystal Compound LC-1

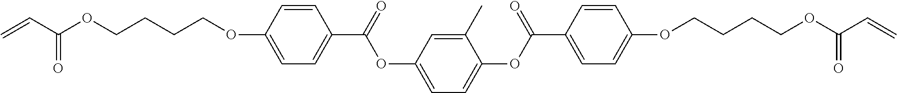 [SMILES: C=CC(=O)OCCCCOc1ccc(C(=O)Oc2ccc(OC(=O)c3ccc(OCCCCOC(=O)C=C)cc3)c(C)c2)cc1]

### Liquid Crystal Compound LC-2

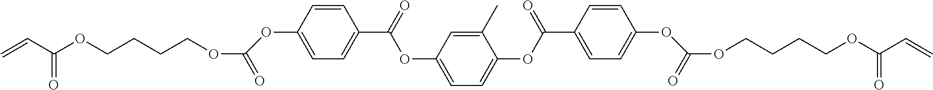 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

### Vertical Alignment Liquid Crystal Compound Alignment Agent S01

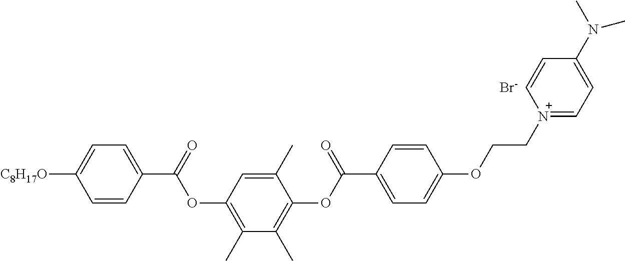

Compound B03 [in the formula, the numerical value described in each repeating unit denotes the content (% by mass) of each repetition with respect to all repeating units; weight-average molecular weight: 15,000]

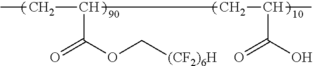

### <Production of Laminate B1>

The laminate B1 was produced by the following procedure.

A broadband dielectric multi-layer film (trade name: APF, manufactured by 3M) was used as a reflective polarizer (linear polarization type reflective polarizer). The positive A-plate side of the obtained retardation layer film 1 was bonded to one surface of the APF, and the alignment film and the support were peeled off. Furthermore, the alignment film was peeled off, the positive C-plate side of the obtained retardation layer film 2 was bonded to the exposed liquid crystal surface with a pressure-sensitive adhesive, and the support and the alignment film were peeled off. Furthermore, the light absorption anisotropic film C1 was laminated on the other surface of the APF by the following lamination method A. In this manner, a laminate B1 (corresponding to the laminate according to the embodiment of the present invention) consisting of the light absorption anisotropic film C1/pressure-sensitive adhesive layer/reflective polarizer/pressure-sensitive adhesive layer/positive A plate/positive C-plate was produced. An elastic modulus of the APF was 4277 MPa.

### (Lamination Method A)

The surface of the light absorption anisotropic film C1 was subjected to a corona treatment at a discharge amount of 150 W min/m², and the surface subjected to the corona treatment and the other surface of the APF were bonded to each other using a pressure-sensitive adhesive. As the pressure-sensitive adhesive, NCF-D692 (manufactured by Lintec Corporation, thickness: 5 μm) was used.

### <Formation of Half Mirror Lens>

A convex surface side of a lens (convex meniscus lens LE1076-A (diameter: 2 inches) manufactured by Thorlabs, Inc.) was subjected to aluminum vapor deposition so that the reflectivity was 40%, thereby forming a half mirror lens.

<Production of Laminate B1K Formed into Curved Surface>

The laminate B1 was set in a forming device. In this case, the positive C-plate side was disposed to be on the lower side. A forming space in the forming device consisted of a box 1 and a box 2 partitioned by the laminate B1, and a mold 1 (convex lens having a diameter of 2 inches and a curvature radius of 84 mm) was disposed in the box 1 on the lower side of the laminate B1 such that a convex surface (forming surface) was on the upper side. In addition, a transparent window was installed on an upper portion of the box 2 on the upper side of the laminate B1, and an IR light source for heating the laminate B1 was installed on an outer side of the window. Next, each of the inside of box 1 and the inside of box 2 was evacuated to 0.1 atm or less by a vacuum pump. Next, as a step of heating the laminate B1, the laminate B1 was irradiated with infrared rays and heated until the temperature of the laminate B1 reached 108° C. Next, as a step of pressing the optical laminate B1 against the mold 1 to deform the optical laminate B1 along a shape of the mold 1, gas was allowed to flow into the box 2 from a gas cylinder to pressurize the box 2 to 300 kPa, and the optical laminate B1 was pressed against the mold 1. Finally, the laminate B1 was removed from the lens which was the mold 1. As a result, the laminate B1 formed into a non-planar shape was obtained.

Next, the laminate B1 formed into a non-planar shape was disposed such that the positive C-plate was on the upper side, with the upper and lower sides being opposite to those in the first forming. In this case, a region of the optical laminate B1, which was formed into a non-planar shape by the first forming, protruded on the lower side. A meniscus lens (diameter: 2 inches, curvature radius of concave surface side: 70 mm) was disposed as a mold 2 such that the concave surface was on the upper side, exactly below the region of the laminate B1 formed into a non-planar shape. Next, each of the inside of box 1 and the inside of box 2 was evacuated to 0.1 atm or less by a vacuum pump. Next, as a step of heating the laminate B1, the laminate B1 was irradiated with infrared rays and heated until the temperature of the laminate B1 reached 108° C. Next, as a step of pressing the optical laminate B1 against the mold 2 to deform the optical laminate B1 along a shape of the mold 2, gas was allowed to flow into the box 2 from a gas cylinder to pressurize the box 2 to 300 kPa, and the optical laminate B1 was pressed against the mold 2. Finally, the laminate B1 was removed from the lens which was the mold 2. As a result, the laminate B1K formed into a curved surface was obtained.

### <Production of Compound Lens>

Regarding the half mirror lens produced above, the laminate B1K was laminated on the concave surface side of the half mirror lens with a pressure-sensitive adhesive to obtain a composite lens 1.

### Example 2

A laminate B2 and a composite lens 2 were obtained according to the same procedure as in Example 1, except that the lamination method A was changed to a lamination method C.

### <Lamination Method C>

The surface of the light absorption anisotropic film C1 was subjected to a corona treatment at a discharge amount of 150 W min/m², and the surface subjected to the corona treatment and the other surface of the APF were bonded to each other using a pressure-sensitive adhesive. As the pressure-sensitive adhesive, the composition described in paragraph 0153 of JP2018-127610A was used, and the adhesion was performed by the method described in paragraph 0161.

### Example 3

A laminate B3 and a composite lens 3 were obtained according to the same procedure as in Example 1, except that the lamination method A was changed to a lamination method F.

### <Lamination Method F>

The surface of the light absorption anisotropic film C1 and the other surface of the APF were bonded to each other using a pressure-sensitive adhesive. As the pressure-sensitive adhesive, a 3% aqueous solution of PVA (PVA-117H, manufactured by Kuraray Co., Ltd.) was used.

### Example 4

A laminate B4 and a composite lens 4 were obtained according to the same procedure as in Example 1, except that the light absorption anisotropic film C2 was used instead of the light absorption anisotropic film C1, and the lamination method A was changed to a lamination method E.

### <Lamination Method E>

The surface of the light absorption anisotropic film C2 and the other surface of the APF were bonded to each other using a pressure-sensitive adhesive. As the pressure-sensitive adhesive, NCF-D692 (manufactured by Lintec Corporation, thickness: 5 μm) was used.

### Example 5

A laminate B5 and a composite lens 5 were obtained according to the same procedure as in Example 1, except that the light absorption anisotropic film C2 was used instead of the light absorption anisotropic film C1.

### Example 6

A laminate B6 and a composite lens 6 were obtained according to the same procedure as in Example 1, except that the light absorption anisotropic film C3 was used instead of the light absorption anisotropic film C1.

### Example 7

A laminate B7 and a composite lens 7 were obtained according to the same procedure as in Example 1, except that the lamination method A was changed to the lamination method D.

### <Lamination Method D>

The surface of the light absorption anisotropic film C1 was subjected to a corona treatment at a discharge amount of 150 W min/m², and the surface subjected to the corona treatment and the other surface of the APF were bonded to each other using a pressure-sensitive adhesive. As the pressure-sensitive adhesive, a 3% aqueous solution of PVA (PVA-117H, manufactured by Kuraray Co., Ltd.) was used.

### Example 8

A laminate B8 and a composite lens 8 were obtained according to the same procedure as in Example 1, except that the lamination method A was changed to the lamination method B.

### <Lamination Method B>

The surface of the light absorption anisotropic film C1 was subjected to a corona treatment at a discharge amount of 150 W min/m², and the surface subjected to the corona treatment and the other surface of the APF were bonded to each other using a pressure-sensitive adhesive. As the pressure-sensitive adhesive, NCF-D692 (manufactured by LINTEC Corporation, thickness: 15 μm) was used.

### Example 9

A laminate B9 and a composite lens 9 were obtained according to the same procedure as in Example 3, except that the light absorption anisotropic film C4 was used instead of the light absorption anisotropic film C1.

### Example 10

A laminate B10 and a composite lens 10 were obtained according to the same procedure as in Example 3, except that the light absorption anisotropic film C5 was used instead of the light absorption anisotropic film C1.

### Example 11

A laminate B11 and a composite lens 11 were obtained according to the same procedure as in Example 3, except that the light absorption anisotropic film C6 was used instead of the light absorption anisotropic film C1.

### Comparative Example 1

A laminate B12 and a composite lens 12 were obtained according to the same procedure as in Example 1, except that the lamination method A was changed to the lamination method E.

### Evaluation

### <Preparation of Virtual Reality Display Device>

A virtual reality display device “Huawei VR Glass” manufactured by Huawei Technologies Co., Ltd., which was a virtual reality display device for which a reciprocating optical system was employed, was disassembled, and all composite lenses were taken out.

The composite lenses produced in Examples and Comparative Example described above were incorporated into the main body instead of the taken-out composite lenses, and the composite lenses were further installed such that the light absorption anisotropic film side in the composite lens was on the eye side, thereby producing a virtual reality display device. In the produced virtual reality display device, a black-and-white checkered pattern was displayed on the image display panel, and the color unevenness was evaluated by visual observation in the following three stages. The results are shown in Table 1.

### (Evaluation of Color Unevenness)

A: color unevenness was slightly visible, but not noticeable.
B: color unevenness is slightly visible, but not noticeable.
C: The color unevenness was visible.

### <Evaluation of Cracks>

20 composite lenses produced in Examples and Comparative Example were produced, and the cracks in the laminate on the concave surface of the composite lens were evaluated by visual observation in the following three stages. The results are shown in Table 1.

### (Evaluation of Cracks)

A: number of sheets on which cracks occurred was 0 or 1.
B: number of sheets on which cracks occurred was 2 to 10.
C: number of sheets on which cracks occurred was 11 to 20.

In Table 1, the column of “Surfactant Log P value” in the column of “Light absorption anisotropic film” indicates the Log P value of the surfactant contained in the light absorption anisotropic film.

In Table 1, the column of “Log P value” in the column of “Pressure-sensitive adhesive layer” indicates the Log P value of the pressure-sensitive adhesive layer.

TABLE 1

| | Configuration requirements | | | | | | | | | | | | |
|---|---|---|---|---|---|---|---|---|---|---|---|---|---|
| | Light absorption anisotropic layer | | | | | | | | | | | | |
| | | | The | | | | | | | | | | |
| | | | number | | | | | | | | | | |
| | | | of | | | | Pressure-sensitive | | | | | | |
| | | | organic | | | | adhesive layer | | | | Evaluation | | |
| | | | dichroic | Thick- | | | | Thick- | | | | Color | |
| | | E1 | coloring | ness | Surfactant | Surface | E2 | ness | | Lamination | E1 + E2 | uneven- | |
| | Type | (mNm⁻¹) | agents | (μm) | LogP | treatment | (mNm⁻¹) | (μm) | LogP | method | (mNm⁻¹) | ness | Crack |
| Example 1 | C1 | 55.6 | 4 | 1.0 | 3.3 | Yes | 32.2 | 5.0 | 0.8 | A | 87.8 | A | A |
| Example 2 | C1 | 55.6 | 4 | 1.0 | 3.3 | Yes | 35.6 | 2.1 | 1.0 | C | 91.2 | A | A |
| Example 3 | C1 | 21.5 | 4 | 1.0 | 3.3 | No | 69.1 | 0.1 | −1.3 | F | 90.6 | A | A |
| Example 4 | C2 | 26.4 | 4 | 1.0 | 1.5 | No | 32.2 | 5.0 | 0.8 | E | 58.6 | A | A |
| Example 5 | C2 | 56.2 | 4 | 1.0 | 1.5 | Yes | 32.2 | 5.0 | 0.8 | A | 88.4 | A | A |
| Example 6 | C3 | 51.5 | 4 | 1.0 | 5.8 | Yes | 32.2 | 5.0 | 0.8 | A | 83.7 | A | A |
| Example 7 | C1 | 55.6 | 4 | 1.0 | 3.3 | Yes | 69.1 | 0.1 | −1.3 | D | 124.7 | A | B |
| Example 8 | C1 | 55.6 | 4 | 1.0 | 3.3 | Yes | 32.2 | 15.0 | 0.8 | B | 87.8 | A | B |
| Example 9 | C4 | 21.4 | 3 | 1.0 | 3.3 | No | 69.1 | 0.1 | 1.3 | F | 90.5 | B | A |
| Example 10 | C5 | 21.6 | 4 | 1.0 | 3.3 | No | 69.1 | 0.1 | −1.3 | F | 90.7 | A | A |
| Example 11 | C6 | 43.7 | 4 | 43.0 | None | No | 69.1 | 0.1 | 1.3 | F | 112.8 | B | A |
| Comparative | C1 | 21.5 | 4 | 1.0 | 3.3 | No | 32.2 | 5.0 | 0.8 | E | 53.7 | C | A |
| Example 1 | | | | | | | | | | | | | |

### Example 1

As shown in Table 1, the laminate according to the embodiment of the present invention exhibited a desired effect.

In particular, from the comparison between Example 11 and other examples, it was found that the effect was more excellent in a case where the thickness of the light absorption anisotropic film was 10.0 μm or less.

In addition, from the comparison between Example 9 and other examples, it was found that the effect was more excellent in a case where the number of organic dichroic coloring agents was 4 or more.

In addition, from the comparison between Example 8 and other examples, it was found that the effect was more excellent in a case where the thickness of the pressure-sensitive adhesive layer was 13.0 μm or less.

In addition, from the comparison between Example 7 and other examples, it was found that the effect was more excellent in a case where E1+E2 was 120 mNm⁻¹ or less.

### Explanation of References

10A, 10B, 10C: laminate
12: light absorption anisotropic film
14: pressure-sensitive adhesive layer
16, 20: retardation layer
18: reflective polarizer
22: positive A-plate
24: positive C-plate
30: composite lens
32: lens
34: half mirror
40: virtual reality display device
42: image display panel
44: circular polarization plate

What is claimed is:

1. A laminate comprising:
a light absorption anisotropic film; and
a pressure-sensitive adhesive layer disposed adjacent to the light absorption anisotropic film,
wherein the light absorption anisotropic film contains an organic dichroic coloring agent, and
a total of a surface free energy E1 of a surface of the light absorption anisotropic film on a pressure-sensitive adhesive layer side and a surface free energy E2 of a surface of the pressure-sensitive adhesive layer on a light absorption anisotropic film side is 54.0 mNm⁻¹ or more.

2. The laminate according to claim 1,
wherein a thickness of the light absorption anisotropic film is 10.0 μm or less.

3. The laminate according to claim 1,
wherein the light absorption anisotropic film contains four or more kinds of the organic dichroic coloring agents.

4. The laminate according to claim 1, further comprising:
an alignment film disposed adjacent to the light absorption anisotropic film on a side of the light absorption anisotropic film opposite to the pressure-sensitive adhesive layer side.

5. The laminate according to claim 1,
wherein a thickness of the pressure-sensitive adhesive layer is 13.0 μm or less.

6. The laminate according to claim 1, further comprising:
an adjacent layer disposed adjacent to the pressure-sensitive adhesive layer on a side of the pressure-sensitive adhesive layer opposite to the light absorption anisotropic film side,
wherein an elastic modulus of the adjacent layer is 100 MPa or more.

7. The laminate according to claim 1,
wherein the light absorption anisotropic film contains a surfactant, and
a Log P value of the surfactant is 3.0 or less.

8. The laminate according to claim 1,
wherein a surface of the light absorption anisotropic film on the pressure-sensitive adhesive layer side is subjected to a surface activation treatment.

9. The laminate according to claim 1,
wherein a Log P value of the pressure-sensitive adhesive layer is 0.5 or less.

10. The laminate according to claim 1, further comprising:
a retardation layer on a side of the pressure-sensitive adhesive layer opposite to the light absorption anisotropic film side.

11. The laminate according to claim 1, further comprising:
a reflective polarizer and a retardation layer on a side of the pressure-sensitive adhesive layer opposite to the light absorption anisotropic film side.

12. A composite lens comprising, in the following order:
the laminate according to claim 1;
a lens; and
a half mirror.

13. A display device comprising:
the laminate according to claim 1.

14. A virtual reality display device comprising:
the laminate according to claim 1.

15. The laminate according to claim 2,
wherein the light absorption anisotropic film contains four or more kinds of the organic dichroic coloring agents.

16. The laminate according to claim 2, further comprising:
an alignment film disposed adjacent to the light absorption anisotropic film on a side of the light absorption anisotropic film opposite to the pressure-sensitive adhesive layer side.

17. The laminate according to claim 2,
wherein a thickness of the pressure-sensitive adhesive layer is 13.0 μm or less.

18. The laminate according to claim 2, further comprising:
an adjacent layer disposed adjacent to the pressure-sensitive adhesive layer on a side of the pressure-sensitive adhesive layer opposite to the light absorption anisotropic film side,
wherein an elastic modulus of the adjacent layer is 100 MPa or more.

19. The laminate according to claim 2,
wherein the light absorption anisotropic film contains a surfactant, and
a Log P value of the surfactant is 3.0 or less.

20. The laminate according to claim 2,
wherein a surface of the light absorption anisotropic film on the pressure-sensitive adhesive layer side is subjected to a surface activation treatment.
